(19) United States
(12) Patent Application Publication
(10) Pub. No.: US 2023/0304632 A1
(43) Pub. Date: Sep. 28, 2023

(54) VEHICLE CHARGED TO POSITIVE POTENTIAL AND HAVING FRICTION NEUTRALIZING-STATIC ELIMINATING TYPE LUBRICATION MECHANISM

(71) Applicants: TOYOTA JIDOSHA KABUSHIKI KAISHA, Toyota-shi, Aichi-ken (JP); KYODO YUSHI CO., LTD., Fujisawa-shi, Kanagawa (JP)

(72) Inventors: Junichi SUDO, Miyoshi-shi, Aichi-ken (JP); Youji KANEHARA, Nagoya-shi, Aichi-ken (JP); Koushi YAMADA, Odawara-shi, Kanagawa-ken (JP); Kenichiro SAKURAI, Toyota-shi, Aichi-ken (JP); Toshio TANAHASHI, Susono-shi, Shizuoka-ken (JP); Ko TANIMURA, Suzuka-shi, Mie-ken (JP); Tomonobu KOMORIYA, Chigasaki-shi, Kanagawa-ken (JP)

(21) Appl. No.: 18/001,332

(22) PCT Filed: Mar. 30, 2021
(86) PCT No.: PCT/IB2021/000182

§ 371 Date: Dec. 9, 2022

(30) Foreign Application Priority Data
Jun. 15, 2020 (JP) 2020-102946

(51) Int. Cl. F16N 39/00

(52) U.S. Cl. CPC F16N 39/00

(57) ABSTRACT

In a vehicle having a microscopic dynamics friction mechanism formed of at least two parts and charged to a positive potential due to traveling, a lubricant in which first additive fine particles made of a resin that generates a negative potential are uniformly mixed with an electrically insulating base oil is disposed in a clearance between members of the friction mechanism. While the first additive fine particles are in frictional contact with the member, neutralization and elimination of the positive potential of the member are started. The first additive fine particles are attracted by a Coulomb force to the positive potential of the surface of the member other than a frictional contact part of the member when floating in the electrically insulating base oil and moving and circulating. The neutralization and elimination of the positive potential of the member are continued.

### BACKGROUND OF THE INVENTION

### 1. Field of the Invention

The present invention relates to a vehicle charged to a positive potential and having a friction neutralizing-static eliminating type lubrication mechanism.

### 2. Description of Related Art

Japanese Patent No. 5321587 describes a conductive grease provided by blending 5 to 20 wt% of carbon black with a DBP oil absorption of 250 ml/100 g or less as a conductive substance and 2 to 9 wt% of fluorine-containing resin particles having an average primary particle diameter of 1.0 µm or less as a thickener in a conductive grease formed of a fluorine oil, a conductive substance and a thickener.

Japanese Patent Nos. 6281501, 6380211, 6124020, 6248962, 6304147, 6183383, 6160603, and 6365316 all describe that in a bearing mechanism of a vehicle that is charged to a positive potential, an air ionization self-discharge type static eliminator is disposed on an outer surface of a specific member to corona-discharge electric charges in the air, whereby the surrounding negative air ions are attracted, and electric charges in a part around the self-discharge type static eliminator are thus neutralized and eliminated.

### SUMMARY OF THE INVENTION

When the conductive grease described in Japanese Patent No. 5321587 is used for a friction mechanism of a vehicle charged to a positive potential, the potential that can be eliminated is limited to the positive potential of a vehicle body.

In all of the air ionization self-discharge type static eliminators described in Japanese Patent Nos. 6281501, 6380211, 6124020, 6248962, 6304147, 6183383, 6160603, and 6365316, the higher the charging potential, the greater the static elimination effect. However, the potential that can be eliminated is limited to a potential of the corona discharge limit.

The present invention provides a friction neutralizing-static eliminating type lubrication mechanism of a vehicle charged to a positive potential.

In a vehicle having a microscopic dynamics friction mechanism formed of at least two parts and charged to a positive potential due to traveling, at least one of members of the friction mechanism is made of a metal material. By a microscopic dynamics frictional force with the member of the friction mechanism, a lubricant in which additive fine particles (for example, PTFE fine particles) made of a resin that generates a negative potential in a triboelectric series table according to the frictional force are uniformly mixed with an electrically insulating base oil is disposed in a clearance between the members of the friction mechanism. Therefore, while the additive fine particles made of the resin are in frictional contact with the member of the friction mechanism, neutralization and elimination of the positive potential of the member of the friction mechanism are started. The additive fine particles made of the resin charged to the negative potential after the frictional contact are attracted by a Coulomb force to the positive potential of the surface of the member of the friction mechanism other than the frictional contact part of the member of the friction mechanism when floating in the electrically insulating base oil and moving and circulating. Accordingly, by the configuration of the vehicle in which the neutralization and elimination of the positive potential of the member of the friction mechanism are continued, the positive potential of the vehicle is significantly reduced.

That is, the present invention includes the following aspects and embodiments.

An aspect of the present invention relates to a vehicle having a microscopic dynamics friction mechanism formed of at least two parts and charged to a positive potential due to traveling. At least one of members of the friction mechanism is made of a metal material. By a microscopic dynamics frictional force with the member of the friction mechanism, a lubricant in which first additive fine particles made of a resin that generates a negative potential compared to the metal material of at least one of the members of the friction mechanism in a triboelectric series table according to the frictional force are uniformly mixed with an electrically insulating base oil is disposed in a clearance between the members of the friction mechanism. While the first additive fine particles are in frictional contact with the member of the friction mechanism, neutralization and elimination of the positive potential of the member of the friction mechanism are started. The first additive fine particles charged to the negative potential after the frictional contact are attracted by a Coulomb force to the positive potential of the surface of the member of the friction mechanism other than the frictional contact part of the member of the friction mechanism when floating in the electrically insulating base oil and moving and circulating. Due to the above-described reasons, the neutralization and elimination of the positive potential of the member of the friction mechanism are continued.

In the aspect, the first additive fine particles may have a primary particle diameter in a range of 0.05 to 1 µm.

In the aspect, the first additive fine particles may have a primary particle diameter in a range of 0.1 to 0.5 µm.

In the aspect, the first additive fine particles may be uniformly mixed in a range of 0.1 to 15 mass% with respect to a total mass of the lubricant.

In the aspect, the first additive fine particles may be uniformly mixed in a range of 5 to 10 mass% with respect to the total mass of the lubricant.

In the aspect, the first additive fine particles may be selected from the group consisting of polytetrafluoroethylene, vinyl chloride, acryl, polyester, polyphthalamide, polyacetal, polybutylene terephthalate, polyphenylene sulfite, polyetheretherketone, polyimide, polyamidoimide, and rubber.

In the aspect, the first additive fine particles may be polytetrafluoroethylene particles.

In the aspect, second additive fine particles having a conductive property may be uniformly mixed with the electrically insulating base oil. When the first additive fine particles charged to the negative potential and the second additive fine particles float in the electrically insulating base oil and move and circulate, the charged negative potential may be carried from the first additive fine particles to the second additive fine particles. The second additive fine particles charged to the negative potential may be attracted by a Coulomb force to the positive potential of the surface of the member of the friction mechanism, and the positive potential of the member of the friction mechanism may be neutralized, eliminated, and reduced.

In the aspect, the second additive fine particles may have a primary particle diameter in a range of 1 to 100 nm.

In the aspect, the second additive fine particles may have a primary particle diameter in a range of 5 to 50 nm.

In the aspect, the second additive fine particles may be uniformly mixed in a range of 0.1 to 15 mass% with respect to the total mass of the lubricant.

In the aspect, the second additive fine particles may be uniformly mixed in a range of 5 to 10 mass% with respect to the total mass of the lubricant.

In the aspect, the second additive fine particles may be selected from the group consisting of carbon black, carbon nanotube, carbon nanohorn, carbon nanofiber, graphene, and graphite.

In the aspect, the second additive fine particles may be carbon black particles.

In the aspect, the first additive fine particles and the second additive fine particles may be uniformly mixed so as to have the same mass ratio of 5 to 10 mass% with respect to the total mass of the lubricant, respectively.

In the aspect, a thickener may be mixed with the electrically insulating base oil and a solid content of the thickener may be adjusted such that a total solid content is 15 to 20 mass% to prepare a grease lubricant with an adjusted viscosity index, and the thickener may be selected from the group consisting of soap-based materials and non-soap-based materials.

In the aspect, the electrically insulating base oil may be selected from the group consisting of paraffinic mineral oils and naphthenic mineral oils.

In the aspect, the electrically insulating base oil may be a paraffinic mineral oil.

In the aspect, the electrically insulating base oil may be selected from the group consisting of hydrocarbon-based synthetic oils such as a poly-a-olefin oil containing 1-decene as a starting material and a co-oligomer oil of α-olefin and ethylene, phenyl ether-based synthetic oils, ester-based synthetic oils, polyglycol-based synthetic oils, silicone oils, and hydrocarbon-based synthetic oils consisting only of carbon and hydrogen atoms.

In the aspect, the other of the members of the friction mechanism may be made of a material that generates a positive potential in the triboelectric series table, and the negative potential generated on the first additive fine particles may be increased to increase an effect of neutralizing, eliminating, and reducing the positive potential of the member of the friction mechanism.

In the aspect, the other of the members of the friction mechanism may be made of a material selected from the group consisting of rayon, nylon, polyphthalamide, polyacetal, polybutylene terephthalate, polyphenylene sulfite, polyetheretherketone, polyimide, and polyamidoimide.

In the aspect, the microscopic dynamics friction mechanism may be a bearing that rolls and rubs against a rolling wheel.

In the aspect, the microscopic dynamics friction mechanism may be a bearing of which parts slide and rub against each other.

In the aspect, the microscopic dynamics friction mechanism may be a gear of which parts rotationally rub against each other.

In the aspect, the microscopic dynamics friction mechanism may be a worm gear of which parts rotationally rub against each other.

In the aspect, the microscopic dynamics friction mechanism may be a belt of which parts rotationally rub against each other.

In the aspect, the microscopic dynamics friction mechanism may include a piston and a cylinder that slide and rub against each other.

In the aspect, the microscopic dynamics friction mechanism may be a slide rail of which parts slide and rub against each other.

In the aspect, the microscopic dynamics friction mechanism may include a sleeve and a spline that slide and rub against each other.

In the aspect, an air ionization self-discharge type static eliminator that ionizes surrounding air with the positive potential of the friction mechanism and neutralizes and eliminates the positive potential of the friction mechanism may be disposed on an outer surface of the friction mechanism near the member where the lubricant is disposed, and a potential of the member where the lubricant is disposed in the friction mechanism may be reduced such that static elimination up to the negative potential is possible by a synergistic effect with the neutralization and static elimination of the lubricant.

According to the present invention, it is possible to provide a friction neutralizing-static eliminating type lubrication mechanism capable of significantly reducing a positive potential of a vehicle during traveling.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a conceptual diagram describing the neutralization and static elimination between first additive fine particles contained in a lubricant and a microscopic dynamics friction mechanism formed of at least two parts in a vehicle of one aspect of the present invention;

FIG. 2 is a conceptual diagram describing a neutralization and static elimination effect in the vehicle of one aspect of the present invention;

FIG. 3 is a conceptual diagram describing a form of neutralization and static elimination between first additive fine particles contained in a lubricant and a microscopic dynamics friction mechanism formed of at least two parts in the vehicle of one aspect of the present invention;

FIG. 4 is a conceptual diagram describing another form of neutralization and static elimination between the first additive fine particles contained in the lubricant and the microscopic dynamics friction mechanism formed of at least two parts in the vehicle of one aspect of the present invention;

FIG. 5 is a schematic diagram showing one embodiment of the vehicle of one aspect of the present invention;

FIG. 6 is a partially enlarged cross-sectional view schematically showing a hub bearing for an axle rolling bearing in one embodiment of the vehicle of one aspect of the present invention in which the microscopic dynamics friction mechanism is the hub bearing for an axle rolling bearing;

FIG. 7 is a schematic diagram showing another embodiment of the vehicle of one aspect of the present invention;

FIG. 8 is a partially enlarged cross-sectional view schematically showing a cross joint of a steering shaft in one embodiment of the vehicle of one aspect of the present invention in which the microscopic dynamics friction mechanism is the cross joint of the steering shaft;

FIG. 9 is a schematic diagram showing still another embodiment of the vehicle of one aspect of the present invention;

FIG. 10 is a partially enlarged cross-sectional view schematically showing a brake pedal in one embodiment of the vehicle of one aspect of the present invention in which the microscopic dynamics friction mechanism is the brake pedal;

FIG. 11 is a partially enlarged cross-sectional view schematically showing an electrically assisted power steering gear in one embodiment of the vehicle of one aspect of the present invention in which the microscopic dynamics friction mechanism is the electrically assisted power steering gear;

FIG. 12 is a partially enlarged cross-sectional view schematically showing a sleeve and a spline of a steering shaft in one embodiment of the vehicle of one aspect of the present invention in which the microscopic dynamics friction mechanism includes the sleeve and the spline of the steering shaft;

FIG. 13 is a partially enlarged cross-sectional view schematically showing a cylinder and a piston of a master or release of a brake in yet still another embodiment of the vehicle of one aspect of the present invention;

FIG. 14 is a schematic diagram showing yet still another embodiment of the vehicle of one aspect of the present invention in which the microscopic dynamics friction mechanism is a differential gear;

FIG. 15 is a schematic diagram showing yet still another embodiment of the vehicle of one aspect of the present invention;

FIG. 16 is a partially enlarged cross-sectional view schematically showing a transmission case housing a CVT metal belt in one embodiment of the vehicle of one aspect of the present invention in which the microscopic dynamics friction mechanism is the CVT metal belt;

FIG. 17 is a schematic diagram showing yet still another embodiment of the vehicle of one aspect of the present invention in which the microscopic dynamics friction mechanism is a sunroof slide rail;

FIG. 18 is a schematic diagram showing yet still another embodiment of the vehicle of one aspect of the present invention in which the microscopic dynamics friction mechanism is a seat slide rail;

FIG. 19 is a conceptual diagram for comparison of a static elimination effect between an embodiment in which a lubricant containing only first additive fine particles is applied and an embodiment in which a lubricant containing first additive fine particles and second additive fine particles is applied in the vehicle of one aspect of the present invention;

FIG. 20 is a conceptual diagram for comparison of a static elimination effect among a reference example in which only an air ionization self-discharge type static eliminator is provided, an embodiment in which a lubricant containing only first additive fine particles is applied, and an embodiment in which a lubricant containing first additive fine particles and second additive fine particles is applied in the vehicle of one aspect of the present invention;

FIG. 21 is a graph showing a steering angle during lane change in a measurement test of steering stability with time;

FIG. 22 is a graph showing values of vehicle yaw angular accelerations at a steering angle of 60°/sec in test vehicles of Example 1 and Comparative Example 1;

FIG. 23A is a graph showing changes in potential of a fender liner during traveling with the passage of time in the test vehicle of Comparative Example 1. The horizontal axis represents the elapsed time (seconds), and the vertical axis represents the potential (kV);

FIG. 23B is a graph showing changes in potential of a fender liner during traveling in a test vehicle of Comparative Example 2. The horizontal axis represents the elapsed time (seconds), and the vertical axis represents the potential (kV);

FIG. 24 is a graph showing, in lubricants of Example 1, Example 3, and Comparative Example 1, voltage drop times (reciprocal of discharging rate) as an index of a discharging rate obtained by a static elimination grease discharge characteristic evaluation device disposed in a clearance between the members of a friction mechanism; and

FIG. 25 is a triboelectric series table showing first additive fine particles made of a resin that generates a negative potential compared to a metal material according to the frictional force in the examples, and resins that generate a positive potential compared to a metal material according to the frictional force in the examples.

### DETAILED DESCRIPTION OF EMBODIMENTS

Hereinafter, preferred embodiments of the present invention will be described in detail.

### Vehicle

In a vehicle having a microscopic dynamics friction mechanism formed of at least two parts and charged to a positive potential due to traveling, at least one of members of the friction mechanism is made of a metal material. By a microscopic dynamics frictional force with the member of the friction mechanism, a lubricant in which first additive fine particles (for example, polytetrafluoroethylene (PTFE) fine particles) made of a resin that generates a negative potential compared to the metal material of at least one of the members of the friction mechanism in the triboelectric series table according to the frictional force are uniformly mixed with an electrically insulating base oil is disposed in a clearance between the members of the friction mechanism. Therefore, while the first additive fine particles made of the resin are in frictional contact with the member of the friction mechanism, neutralization and elimination of the positive potential of the member of the friction mechanism are started. Furthermore, the first additive fine particles made of the resin charged to the negative potential even after the frictional contact are attracted by the Coulomb force to the positive potential of the surface of the member of the friction mechanism other than the frictional contact part when floating in the electrically insulating base oil and moving and circulating rapidly and freely. Accordingly, by the configuration of the vehicle in which the neutralization and elimination of the positive potential of the member of the friction mechanism can be continued, the positive potential of the vehicle is significantly reduced.

In another aspect of the present invention, second additive fine particles (for example, carbon black fine particles) having a conductive property are uniformly mixed with the electrically insulating base oil. When the first additive fine particles charged to the negative potential and the second additive fine particles having a conductive property float in the electrically insulating base oil and move and circulate rapidly and freely, the charged negative potential is carried from the floating first additive fine particles to the floating second additive fine particles. The negatively charged second additive fine particles having a conductive property are also attracted by the Coulomb force to the positive potential of the surface of the member of the friction mechanism. By the configuration of the vehicle in which the positive potential of the member of the friction mechanism can be rapidly neutralized and eliminated, the positive potential of the vehicle is significantly reduced.

In still another aspect of the present invention, an air ionization self-discharge type static eliminator that ionizes the surrounding air with the positive potential of the friction mechanism and neutralizes and eliminates the positive potential of the friction mechanism is disposed on an outer surface of the friction mechanism near the member where the lubricant is disposed. By the configuration of the vehicle in which the potential of the member where the lubricant is disposed in the friction mechanism is reduced to obtain a synergistic effect with the neutralization and static elimination of the lubricant, the vehicle can be allowed to undergo the static elimination up to the negative potential.

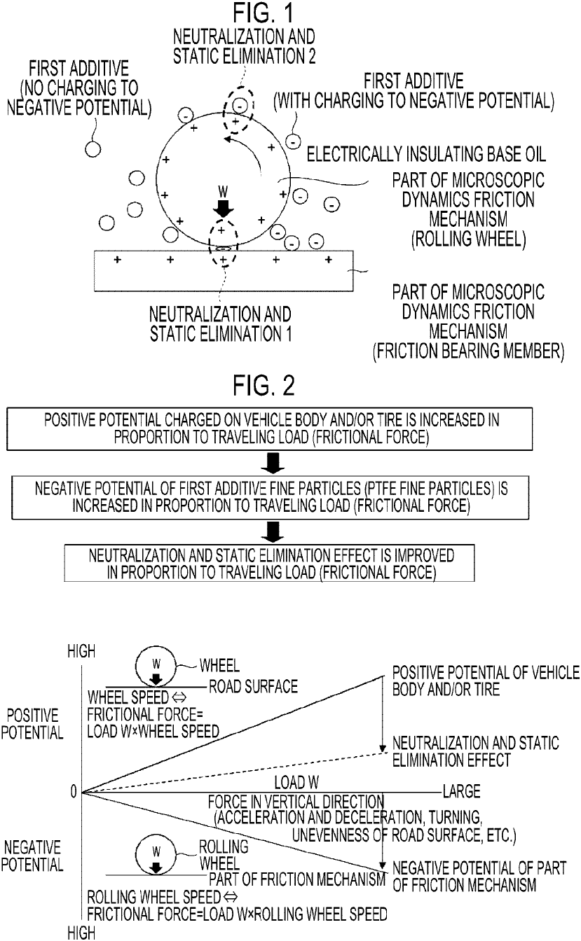

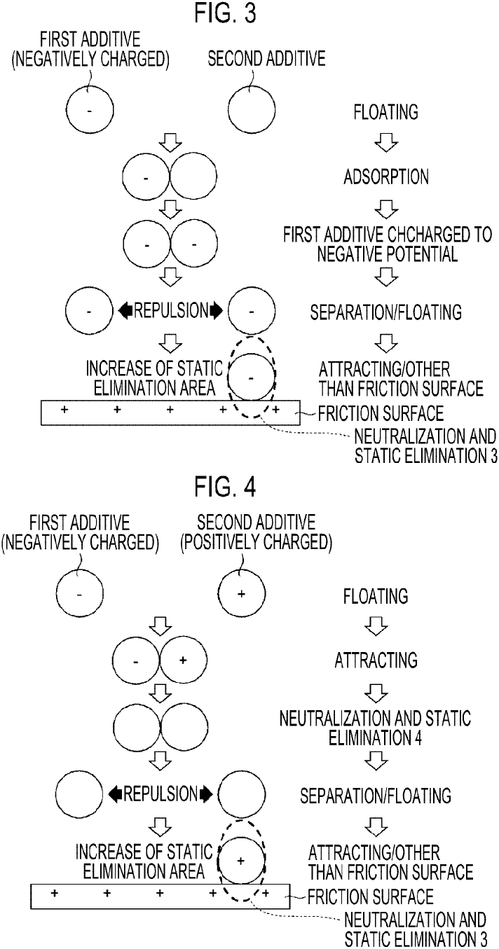

FIG. 1 shows a schematic diagram describing the neutralization and static elimination between first additive fine particles contained in a lubricant and a microscopic dynamics friction mechanism formed of at least two parts in the vehicle of this aspect, and FIG. 2 shows a schematic diagram describing a neutralization and static elimination effect in the vehicle of this aspect. The reason why the actions and effects described above can be obtained in each aspect of the present invention can be described as follows. Each aspect of the present invention is not limited to the following actions and principles. A vehicle body of the vehicle is usually positively charged by the friction between a tire and a road surface and/or the disturbance due to traveling. The air is usually positively charged. Accordingly, when the vehicle travels, an electrostatic repulsive force is generated between a surface of the vehicle body and the air, and a repulsion is generated in a direction away from the vehicle against the air flow near the surface of the vehicle body. In addition, the tire of the vehicle is usually positively charged due to the contact with the road surface. In particular, the content of silica that is used in the tire is increased due to the increasing demand for energy-saving tires. A tire having such a high silica content tends to be positively charged. As a result of the charging described above, the vehicle cannot obtain desired aerodynamic performance and/or traveling performance, and as a result, steering stability and the like may be reduced. In the microscopic dynamics friction mechanism (for example, axle rolling bearing) “formed of at least two parts” in the vehicle in which, for example, the vehicle body is charged to a positive potential due to traveling, at least one of members of the friction mechanism of this aspect is made of a metal material. By a microscopic dynamics frictional force with the member of the friction mechanism, a lubricant in which first additive fine particles (for example, PTFE fine particles) made of a resin that generates a negative potential compared to the metal material of at least one of the members of the friction mechanism in the triboelectric series table according to the frictional force are uniformly mixed with an electrically insulating base oil is disposed in a clearance between the members of the friction mechanism. Therefore, while the first additive fine particles made of the resin are in frictional contact with the member of the friction mechanism, neutralization and elimination of the positive potential of the member of the friction mechanism are started. Furthermore, the first additive fine particles made of the resin charged to the negative potential even after the frictional contact are attracted by the Coulomb force to the positive potential of the surface of the member of the friction mechanism other than the frictional contact part when floating in the electrically insulating base oil and moving and circulating rapidly and freely (FIGS. 3 and 4). Accordingly, by applying the configuration of the vehicle in which the neutralization and elimination of the positive potential of the member of the friction mechanism can be continued, for example, the positive electric charge charged on the vehicle body surface and/or the tire via the microscopic dynamics friction mechanism (for example, axle rolling bearing) is removed to approach the original performance of the vehicle, whereby steering stability and the like can be improved.

In each aspect of the present invention, the steering stability of the vehicle means stability of kinematic performance mainly related to steering among basic kinematic performances of the vehicle, such as “running, turning, and stopping”. The steering stability of the vehicle can be defined based on, for example, followability and responsiveness of the vehicle when a driver of the vehicle actively performs the steering operation, course retention of the vehicle when a driver of the vehicle does not actively perform the steering operation, convergence relative to external factors such as a road surface shape or crosswind, and the like. In each aspect of the present invention, the improvement is not limited to the improvement in steering stability of the vehicle, but for example, second additive fine particles (for example, carbon black fine particles) having a conductive property are uniformly mixed with the electrically insulating base oil of the one aspect of the present invention. When the first additive fine particles generating the negative potential and the second additive fine particles float in the electrically insulating base oil and move and circulate rapidly and freely, the charged negative potential is carried from the floating first additive fine particles to the floating second additive fine particles. A test vehicle in which the negatively charged second additive fine particles are also attracted to the positive potential of the surface of the member of the friction mechanism, and the positive potential of the member of the friction mechanism can be rapidly neutralized, eliminated, and reduced can be prepared, and the potential of a vehicle body of the test vehicle can be quantitatively measured. In the method, for example, with the presence or absence of this embodiment, the test vehicle can be manually close-loop driven, and the surface potential of the same part of a fender liner facing a tire tread surface can be measured in a non-contact manner and compared.

In each aspect of the present invention, the vehicle means a vehicle having four, two, or other number of rubber tire wheels and provided with a prime mover such as an engine or a motor. Hereinafter, in this specification, a manually driving vehicle and an automatic driving vehicle included in the above definition will be simply referred to as “vehicle”.

In a vehicle to which this aspect is applied, an air ionization self-discharge type static eliminator can be disposed in a vehicle body (for example, attached to a bumper, a wheel house, or an undercover). The air ionization self-discharge type static eliminator is not limited, but is preferably, for example, an aluminum foil adhesive tape having discharge protrusions on an outer surface thereof, a metallic paint, or a carbon particle paint. By applying the air ionization self-discharge type static eliminator to the vehicle of this aspect, the positive electric charge charged on the vehicle body surface and/or the tire can be primarily removed via the air ionization self-discharge type static eliminator. Accordingly, by the friction neutralizing-static eliminating type lubrication mechanism of this aspect, secondary static elimination up to the negative potential is possible, and the steering stability of the vehicle can be further improved.

In the vehicle of this aspect, the microscopic dynamics friction mechanism can be applied to various mechanisms to be mounted on the vehicle, such as an axle rolling bearing. In the vehicle of this aspect, the axle rolling bearing is a rolling bearing supporting the axle in the vehicle, that means a metal member called a rolling bearing device for wheel support, an axle bearing, a hub unit, a hub bearing, a wheel hub bearing, a wheel bearing, or the like in the art. The axle rolling bearing usually has a structure in which a hub wheel for mounting of a wheel of an automobile or the like is rotatably supported via double-row rolling bearings. As the metal axle rolling bearing of an automobile or the like to which the lubricant is applied, for example, various bearings that are usually used in the art, such as a double-row angular ball bearing and a double-row conical roller bearing, may be used.

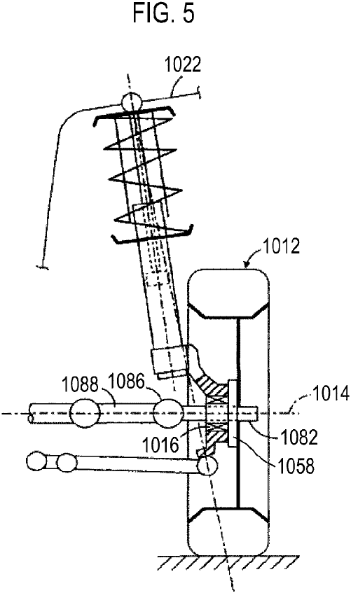

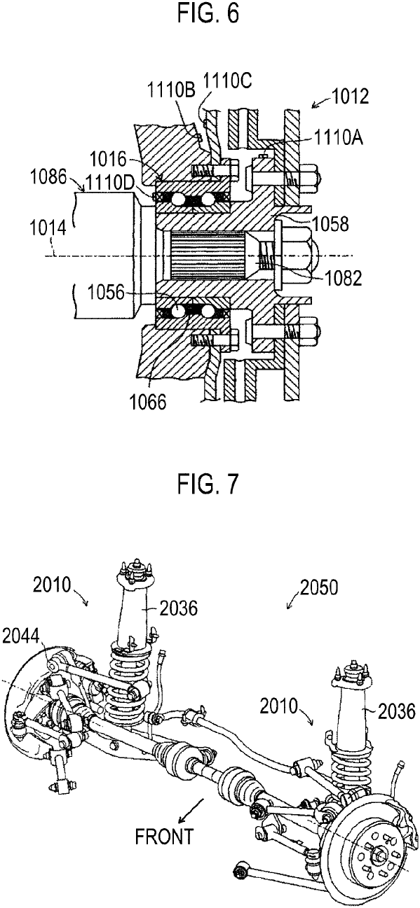

In the vehicle of this aspect, the microscopic dynamics friction mechanism can be applied to various mechanisms to be mounted on the vehicle, including an axle rolling bearing. For example, the microscopic dynamics friction mechanism is preferably a bearing that rolls and rubs against a rolling wheel. In addition, a hub bearing for an axle rolling bearing for improving steering stability of a vehicle, a continuously variable transmission (CVT) joint, and various electric motor bearings are more preferable as the microscopic dynamics friction mechanism. The vehicle of this embodiment can be applied to, for example, the vehicle disclosed in Japanese Patent No. 6281501. For example, FIG. 5 shows one embodiment of the vehicle of this aspect in which the microscopic dynamics friction mechanism is a hub bearing for an axle rolling bearing, and FIG. 6 shows a partially enlarged cross-sectional view schematically showing the hub bearing for an axle rolling bearing in the embodiment. As shown in FIG. 5, the vehicle of this embodiment has a wheel 1012, a vehicle body 1022, a bearing 1016, a hub 1058, an axle 1082, an universal joint 1086, and an intermediate shaft 1088. An inner end of the axle 1082 is connected to an outer end of the intermediate shaft 1088 by the universal joint 1086. As shown in FIG. 6, the bearing 1016 has an inner race as a rotary race member, an outer race as a stationary race member, and balls 1056 as a plurality of rolling elements interposed between the inner race and the outer race. The hub 1058 constitutes a rotary support member that supports the bearing 1016 in cooperation with a knuckle. An internal space of the bearing 1016 is filled with a grease 1066 as a lubricant so that the friction between the ball 1056 and the inner and outer races is reduced by the grease 1066. A resin sealing member is disposed at both ends of the bearing 1016, and is fixed to the outer race by, for example, press fitting. Therefore, electric charges can be transferred between the outer race and the sealing member. A strip-shaped air ionization self-discharge type static eliminator 1110A is preferably fixed in an adhesion manner to a cylindrical surface of a flange portion of the hub 1058 so as to extend in the circumferential direction. Strip-shaped air ionization self-discharge type static eliminators 1110B and 1110C are preferably fixed in an adhesion manner to an outer surface of the knuckle in the lateral direction of the vehicle and an inner surface of the brake back plate in the lateral direction of the vehicle so as to extend vertically in the radial direction. A strip-shaped air ionization self-discharge type static eliminator 1110D is preferably fixed in an adhesion manner to an outer surface of the sealing member on the inner side in the lateral direction of the vehicle so as to extend in the circumferential direction.

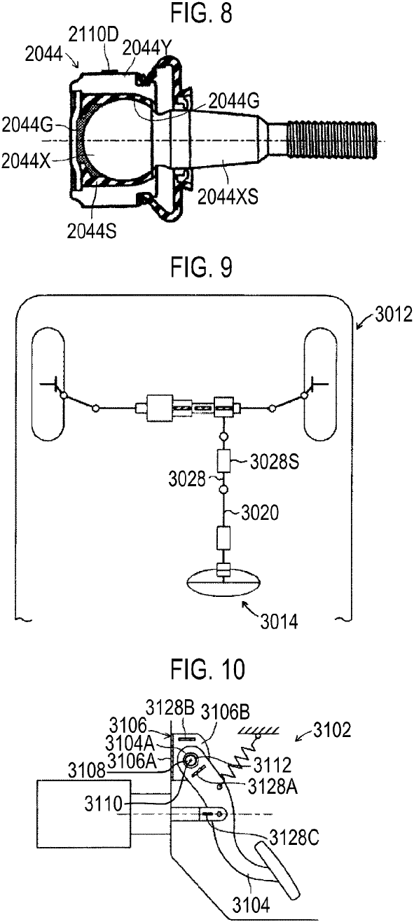

In another embodiment of the vehicle of this aspect, the microscopic dynamics friction mechanism is preferably a bearing of which the parts slide and rub against each other, and is more preferably a brake pedal or clutch pedal, a brake master or clutch master, or a cross joint of a shock absorber, a propeller shaft, or a steering shaft. The vehicle of this embodiment can be applied to, for example, the vehicle disclosed in Japanese Patent No. 6124020, 6281501, 6304147, or 6380211. For example, FIG. 7 shows one embodiment of the vehicle of this aspect in which the microscopic dynamics friction mechanism is a cross joint of a steering shaft, and FIG. 8 shows a partially enlarged cross-sectional view schematically showing the cross joint of the steering shaft in the embodiment. As shown in FIG. 7, a vehicle 2050 of this embodiment has right and left wheels, a suspension 2010, a shock absorber 2036, and a ball joint 2044. The suspension 2010 has a wheel support member (knuckle) and a plurality of links. The suspension 2010 and the wheel support member (knuckle) are connected via the ball joint 2044 and the links. As shown in FIG. 8, the ball joint 2044 includes a ball member 2044X and a socket 2044Y that pivotally supports the ball member 2044X, and the socket 2044Y is formed integrally with an outer end of the link. A resin sheet member 2044S is interposed between a ball portion of the ball member 2044X and the socket 2044Y, and a sliding portion between the ball portion and the seat member 2044S is lubricated with a grease 2044G as a lubricant. The ball member 2044X has a stem portion 2044XS, and the stem portion 2044XS is mounted on a sleeve portion provided in the wheel support member. An air ionization self-discharge type static eliminator 2110D is preferably fixed to a cylindrical outer surface of the socket 2044Y of the ball joint 2044.

For example, FIG. 9 shows one embodiment of the vehicle of this aspect in which the microscopic dynamics friction mechanism is a brake pedal or clutch pedal, and FIG. 10 shows a partially enlarged cross-sectional view schematically showing the brake pedal or clutch pedal in the embodiment. As shown in FIG. 9, a vehicle 3012 of this embodiment includes a steering wheel 3014, a displacement transmission system that transmits the rotational displacement of the steering wheel 3014 to a steering actuator, and a brake pedal (not shown). As shown in FIG. 10, a brake pedal 3102 has a pedal 3104 and a bracket 3106. The bracket 3106 has a base portion 3106A fixed to a vehicle body and a pair of plate-shaped support portions 3106B formed integrally with the base portion 3106A and separated from each other in the lateral direction of the vehicle. The pedal 3104 and the bracket 3106 are made of a conductive metal, but at least one of them may be made of a resin. A boss portion 3104A is provided at an upper end portion of the pedal 3104, and a pivot 3108 extending along the lateral direction of the vehicle is inserted into the boss portion 3104A. The pivot 3108 is supported at both ends thereof by the support portions 3106B, and thus the pedal 3104 is pivotally supported around an axis 3110 of the pivot 3108. A grease 3112 as a lubricant is interposed between the boss portion 3104A and the pivot 3108 so that the pedal 3104 can smoothly pivot around the axis 3110. In the brake pedal 3102, an air ionization self-discharge type static eliminator 3128A is preferably fixed in an adhesion manner to one outer surface of the pedal 3104 in the vicinity of the pivot 3108.

In still another embodiment of the vehicle of this aspect, the microscopic dynamics friction mechanism preferably includes a piston and a cylinder that slide and rub against each other, and more preferably includes a cylinder and a piston of a master or release of a brake or clutch. The vehicle of this embodiment can be applied to, for example, the vehicle disclosed in Japanese Patent No. 6248962. For example, FIG. 13 shows a partially enlarged cross-sectional view schematically showing the cylinder and the piston of the master or release of the brake in one embodiment of the vehicle of this aspect in which the microscopic dynamics friction mechanism includes the cylinder and the piston of the master or release of the brake. As shown in FIG. 13, the vehicle of this embodiment has a wheel 4012, a brake disk 4020 that is a rotary member rotating around a rotation axis together with the wheel 4012, brake pads 4022 and 4024 which are friction members, and a pressing device that presses the brake pads 4022 and 4024 against the brake disk 4020. A slide pin 4040 and a sliding portion of a slide pin hole 4044, that is, a cylindrical surface of the slide pin 4040 and a wall surface of the slide pin hole 4044 are lubricated with a grease 4050 as a lubricant. A strip-shaped self-discharge type static eliminator 4070A is preferably fixed in an adhesion manner to a cylindrical outer surface of a step portion of the brake disk 4020 so as to extend in the circumferential direction. A strip-shaped air ionization self-discharge type static eliminator 4070B is preferably fixed in an adhesion manner to upper and lower surfaces of the back plate of the brake pad 4024 so as to substantially extend in the circumferential direction. A strip-shaped air ionization self-discharge type static eliminator 4070C is preferably fixed in an adhesion manner to an outer surface of a part of the caliper support member that receives the slide pin 4040. A strip-shaped air ionization self-discharge type static eliminator 4070D is preferably fixed in an adhesion manner to each flange portion of the caliper so as to substantially extend in the radial direction. Strip-shaped air ionization self-discharge type static eliminators 4070E and 4070F are preferably fixed in an adhesion manner to an outer surface and an inner surface of the caliper in the radial direction so as to extend perpendicular to the radial direction and the axis, respectively. A strip-shaped air ionization self-discharge type static eliminator 4070G is preferably fixed in an adhesion manner to an outer end surface of the caliper in the lateral direction of the vehicle so as to extend perpendicular to the radial direction and the axis.

In yet still another embodiment of the vehicle of this aspect, the microscopic dynamics friction mechanism is preferably a gear of which the parts rotationally rub against each other, and is more preferably a differential gear or a transmission gear. For example, FIG. 14 shows a schematic diagram showing one embodiment of the vehicle of this aspect in which the microscopic dynamics friction mechanism is a differential gear. As shown in FIG. 14, the vehicle of this embodiment has an axle 5018 and a differential gear unit 5053. The differential gear unit 5053 is lubricated with a grease as a lubricant. An air ionization self-discharge type static eliminator 5100 is preferably fixed to an outer surface of the differential gear unit 5053.

In yet still another embodiment of the vehicle of this aspect, the microscopic dynamics friction mechanism is preferably a worm gear of which the parts rotationally rub against each other, and is more preferably an electrically assisted power steering (PS) gear or a steering gear. The vehicle of this embodiment can be applied to, for example, the vehicle disclosed in Japanese Patent No. 6124020. FIG. 9 shows one embodiment of the vehicle of this aspect in which the microscopic dynamics friction mechanism is an electrically assisted PS gear, and FIG. 11 shows a partially enlarged cross-sectional view schematically showing the electrically assisted PS gear in the embodiment. As shown in FIG. 9, the vehicle 3012 of this embodiment has a steering wheel 3014, a displacement transmission system that transmits the rotational displacement of the steering wheel 3014 to a steering actuator, and an electrically assisted PS gear device (not shown). As shown in FIG. 11, an electrically assisted power steering device 3082 has an electric motor 3088 that rotationally drives a worm gear 3084 around a rotation axis 3086. The rotation axis 3086 is separated from a rotation axis 3036 of an upper steering shaft 3020 and extends perpendicular to the rotation axis 3036. The worm gear 3084 engages with a worm wheel 3090 provided integrally with the upper steering shaft 3020. The worm gear 3084 and the worm wheel 3090 are housed in a housing 3092. The housing 3092 is filled with a grease 3094 as a lubricant to reduce the friction between the worm gear 3084 and the worm wheel 3090. An air ionization self-discharge type static eliminator 3100 is preferably fixed to an outer surface of the housing 3092 of the electrically assisted power steering device 3082.

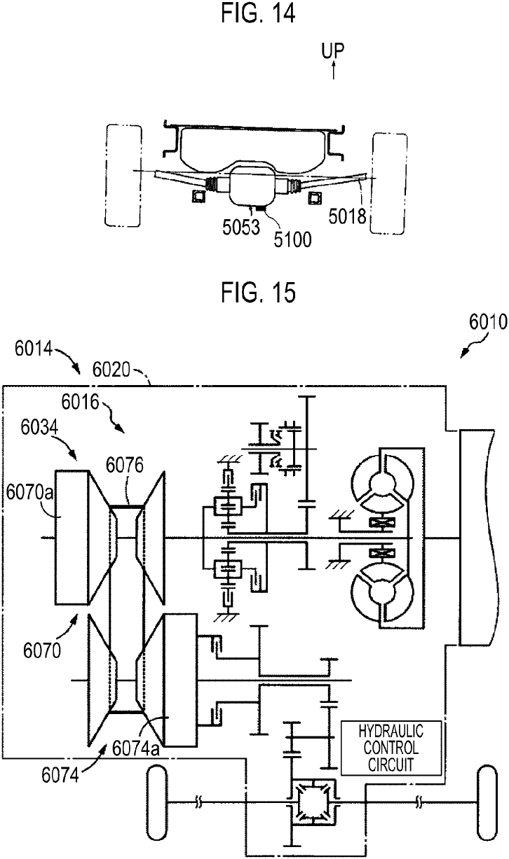

In yet still another embodiment of the vehicle of this aspect, the microscopic dynamics friction mechanism is preferably a belt of which the parts rotationally rub against each other, and is more preferably a CVT metal belt. For example, FIG. 15 shows a schematic diagram showing one embodiment of the vehicle of this aspect in which the microscopic dynamics friction mechanism is a CVT metal belt, and FIG. 16 shows a partially enlarged cross-sectional view schematically showing the CVT in the embodiment. As shown in FIG. 15, a vehicle 6010 of this embodiment has a transaxle 6014, an automatic transmission 6016, and a transmission case 6020 housing the automatic transmission 6016. The automatic transmission 6016 has a belt type continuously variable transmission 6034, and the belt type continuously variable transmission 6034 has a primary pulley 6070 and a secondary pulley 6074 having a variable effective diameter, a CVT belt 6076 wound around the primary pulley 6070 and the secondary pulley 6074, and hydraulic actuators 6070a and 6074a. The CVT belt 6076 is lubricated with a grease as a lubricant. As shown in FIG. 16, an air ionization self-discharge type static eliminator 6100 is preferably fixed to an outer surface of the transmission case 6020.

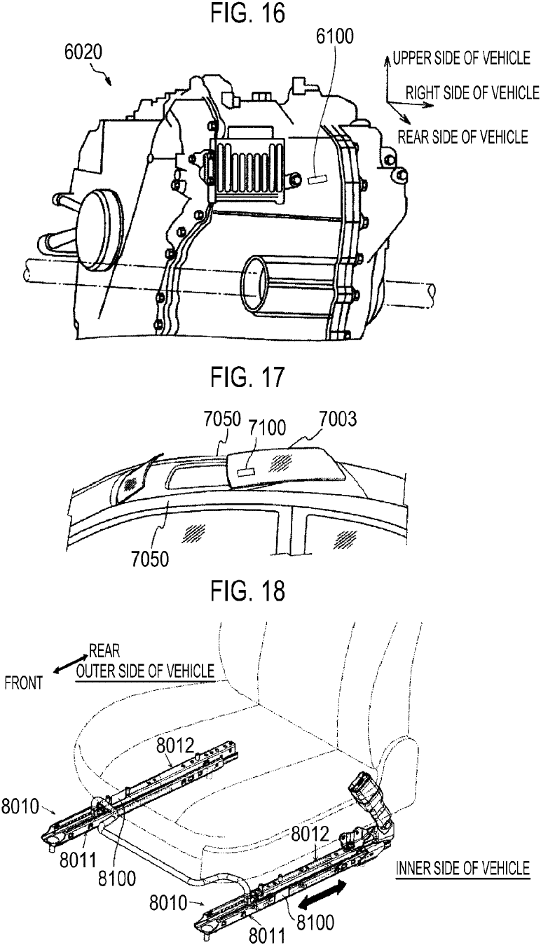

In yet still another embodiment of the vehicle of this embodiment, the microscopic dynamics friction mechanism is preferably a slide rail of which the parts slide and rub against each other, and is more preferably a seat slide rail, a sunroof slide rail, or a brake pad holding portion. For example, FIG. 17 shows a schematic diagram one embodiment of the vehicle of this aspect in which the microscopic dynamics friction mechanism is a sunroof slide rail. As shown in FIG. 17, the vehicle of this embodiment has a slide panel 7003 and right and left roof side rails 7050. The roof side rail 7050 is lubricated with a grease as a lubricant. An air ionization self-discharge type static eliminator 7100 is preferably fixed to an outer surface of the slide panel 7003.

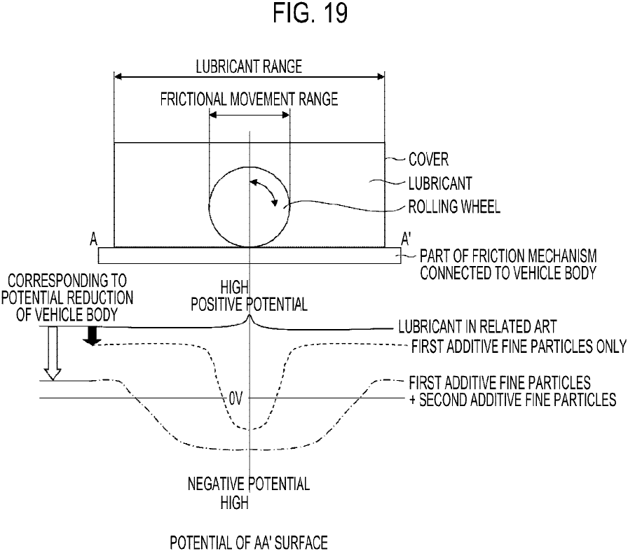

For example, FIG. 18 shows a schematic diagram showing one embodiment of the vehicle of this aspect in which the microscopic dynamics friction mechanism is a seat slide rail. As shown in FIG. 18, the vehicle of this embodiment has a seat, a seat slide rail 8010, a lower rail 8011, and an upper rail 8012. The lower rail 8011 and the upper rail 8012 are lubricated with a grease as a lubricant. An air ionization self-discharge type static eliminator 8100 is preferably fixed to an outer surface of the lower rail 8011.

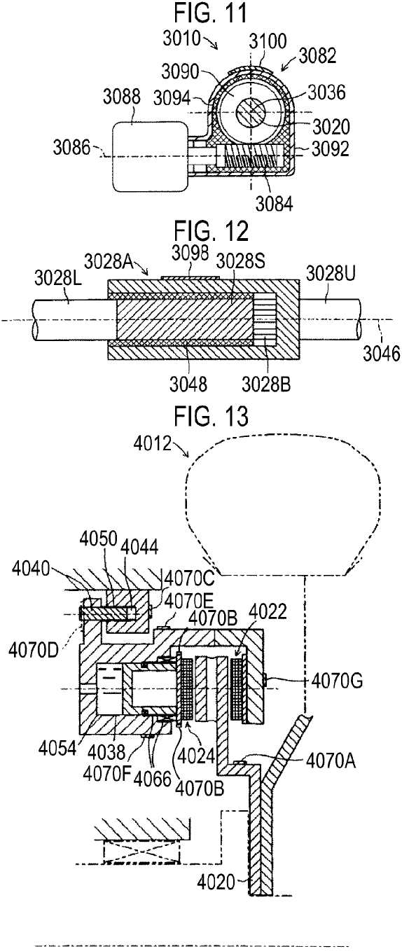

In yet still another embodiment of the vehicle of this aspect, the microscopic dynamics friction mechanism preferably includes a sleeve and a spline that slide and rub against each other, and more preferably include a sleeve and a spline, or a ball screw and a ball spline of a propeller shaft or steering shaft. The vehicle of this embodiment can be applied to, for example, the vehicle disclosed in Japanese Patent No. 6124020. For example, FIG. 9 shows one embodiment of the vehicle of this aspect in which the microscopic dynamics friction mechanism includes a sleeve and a spline of a steering shaft, and FIG. 12 shows a partially enlarged cross-sectional view schematically showing the sleeve and the spline of the steering shaft. As shown in FIG. 9, the vehicle 3012 of this embodiment has a steering wheel 3014, a displacement transmission system that transmits the rotational displacement of the steering wheel 3014 to a steering actuator, an upper steering shaft 3020, an intermediate shaft 3028, and a spline shaft 3028S. As shown in FIG. 12, a part where an upper shaft portion 3028U and a lower shaft portion 3028L are fitted to each other is provided with a spline connecting portion 3028A having a spline bearing 3028B and a spline shaft 3028S. The spline bearing 3028B and the spline shaft 3028S have a plurality of spline grooves and spline teeth that are separated from each other at even intervals around a rotation axis 3046 and extend along the rotation axis 3046. Each spline tooth is fitted into a corresponding spline groove, and the engaging portion of the spline groove and the spline tooth is filled with a grease 3048 as a lubricant. An air ionization self-discharge type static eliminator 3098 is preferably fixed to an outer surface of the spline connecting portion 3028A.

In the lubricant applied to the microscopic dynamics friction mechanism of the vehicle of this aspect, the electrically insulating base oil can be appropriately selected from various base oils such as mineral oils and synthetic oils usually used in the art. The mineral oil contained in the lubricant may be either a paraffinic mineral oil or a naphthenic mineral oil, and is preferably a paraffinic mineral oil. The mineral oil is preferably manufactured by, for example, appropriately combining one or more optional refining means selected from vacuum distillation, oil deasphalting, solvent extraction, hydrocracking, solvent dewaxing, sulfuric acid washing, clay refining, and hydrorefining. The synthetic oil contained in the lubricant may be any one of known synthetic oils such as hydrocarbon-based synthetic oils such as a poly-α-olefin oil containing 1-decene as a starting material and a co-oligomer oil of α-olefin and ethylene, phenyl ether-based synthetic oils, ester-based synthetic oils, polyglycol-based synthetic oils, and silicone oils, and hydrocarbon-based synthetic oils consisting only of carbon and hydrogen atoms are preferable.

The electrically insulating base oil may be formed of any one of the mineral oils and the synthetic oils exemplified above, or of a mixture of a plurality of mineral oils and/or synthetic oils. The electrically insulating base oil is preferably formed only of a mineral oil. In a case where the electrically insulating base oil is formed only of a mineral oil, the cost can be reduced. Since the electrically insulating base oil having the characteristics is contained, the lubricant can exhibit desired fluidity when being applied to the microscopic dynamics friction mechanism of the vehicle of this aspect.

In the lubricant, the electrically insulating base oil preferably has a kinematic viscosity in a range of 40 to 200 mm²/s at 40° C., and more preferably has a kinematic viscosity in a range of 60 to 100 mm²/s. In a case where the kinematic viscosity of the electrically insulating base oil is less than the lower limit, a sufficient oil film cannot be formed in the microscopic dynamics friction mechanism (for example, axle rolling bearing) of the vehicle of this aspect to which the lubricant is applied, and thus the friction surface of the microscopic dynamics friction mechanism (for example, the rolling surface of the axle rolling bearing) may be damaged. In a case where the kinematic viscosity of the electrically insulating base oil is greater than the upper limit, the viscous resistance of the lubricant may increase, and thus a torque increase and the generation of heat may occur in the microscopic dynamics friction mechanism (for example, axle rolling bearing) of the vehicle of this aspect to which the lubricant is applied. Accordingly, in a case where an electrically insulating base oil having a kinematic viscosity in the above range is contained, the lubricant forms a sufficient oil film in the microscopic dynamics friction mechanism of the vehicle of this aspect to which the lubricant is applied, thereby exhibiting desired fluidity.

In each aspect of the present invention, the kinematic viscosity of the electrically insulating base oil or the like is not limited, but can be measured based on JISK2283 using, for example, a glass capillary viscometer.

In the lubricant, a thickener can be appropriately selected from various materials such as soap-based materials and non-soap-based materials usually used in the art. Examples of the soap-based material include lithium soap. Examples of the non-soap-based material include organic materials, such as a diurea compound and a fluorine powder, and inorganic materials, such as a silica powder, titania, alumina, and carbon fiber. In each aspect of the present invention, the diurea compound is usually a compound represented by Formula (I):

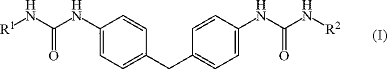

In Formula (I), R¹ and R² each independently represent preferably a substituted or unsubstituted C₆-C₂₀ alkyl or substituted or unsubstituted C₆-C₁₈ aryl, more preferably a substituted or unsubstituted C₆-C₁₈ aryl, and even more preferably a substituted or unsubstituted phenyl. It is particularly preferable that both R¹ and R² are 4-methylphenyl. In each aspect of the present invention, the diurea compound represented by Formula (I) in which R¹ and R² each independently represent a substituted or unsubstituted C₆-C₁₈ aryl may be described as an “aromatic diurea compound”. The thickener contained in the lubricant is preferably a diurea compound, lithium soap, or a mixture of the diurea compound and the lithium soap, more preferably a diurea compound, and even more preferably an aromatic diurea compound. Since the thickener having the characteristics is contained, the lubricant applied to the microscopic dynamics friction mechanism of the vehicle of this aspect can exhibit a high inflow property.

The thickener is preferably contained in the lubricant in such an amount that the mixing consistency of the lubricant is in a range of 220 to 385. The mixing consistency is more preferably in a range of 265 to 340. The content of the thickener satisfying the requirement is adjusted so that a total solid content (mass%) is about 15 to 20 mass% with respect to the total mass of the lubricant, and is usually in a range of 2 to 30 mass%, typically in a range of 3 to 25 mass%, and particularly in a range of 4 to 20 mass%. In a case where the content of the thickener is greater than the upper limit, the lubricant may not be sufficiently distributed in the microscopic dynamics friction mechanism (for example, axle rolling bearing) of the vehicle of this aspect to which the lubricant is applied. In a case where the content of the thickener is less than the lower limit, the lubricant may be excessively softened and may leak from the microscopic dynamics friction mechanism (for example, axle rolling bearing) of the vehicle of this aspect to which the lubricant is applied. Accordingly, in a case where a thickener having a mixing consistency in the above range is contained, the lubricant can exhibit desired fluidity without leaking from the microscopic dynamics friction mechanism (for example, axle rolling bearing) of the vehicle of this aspect to which the lubricant is applied.

The mixing consistency of the lubricant can be measured based on, for example, JISK22207.

In the lubricant applied to the microscopic dynamics friction mechanism of the vehicle of this aspect, the first additive fine particles made of a resin that generates a negative potential in the triboelectric series table are preferably selected from the group consisting of PTFE, vinyl chloride, acryl, polyester, polyphthalamide, polyacetal, polybutylene terephthalate, polyphenylene sulfite, polyetheretherketone, polyimide, polyamidoimide, and rubber, and are more preferably PTFE particles. The resin of the first additive fine particles exemplified above has been known to be a material that is easily negatively charged due to the friction with a metal material or a material that generates a positive potential in the triboelectric series table. Accordingly, in the microscopic dynamics friction mechanism (for example, axle rolling bearing) formed of at least two parts in the vehicle charged to a positive potential due to traveling in this aspect, at least one of members of the friction mechanism is made of a metal material, and by a microscopic dynamics frictional force with the member of the friction mechanism, a lubricant in which first additive fine particles (for example, PTFE fine particles) made of a resin that generates a negative potential compared to the metal material of at least one of the members of the friction mechanism in the triboelectric series table according to the frictional force are uniformly mixed with an electrically insulating base oil is disposed in a clearance between the members of the friction mechanism. Therefore, while the first additive fine particles made of the resin are in frictional contact with the member of the friction mechanism, neutralization and elimination of the positive potential of the member of the friction mechanism are started. Furthermore, the first additive fine particles made of the resin charged to the negative potential even after the frictional contact are attracted by the Coulomb force to the positive potential of the surface of the member of the friction mechanism other than the frictional contact part when floating in the electrically insulating base oil and moving and circulating rapidly and freely. Accordingly, by the configuration of the vehicle in which the neutralization and elimination of the positive potential of the member of the friction mechanism can be continued, the positive potential of the vehicle is significantly reduced. For example, the positive electric charge charged on the vehicle body surface and/or the tire via the microscopic dynamics friction mechanism (for example, axle rolling bearing) is removed to approach the original vehicle performance, whereby steering stability and the like can be improved.

The primary particle diameter of the first additive fine particles (for example, PTFE fine particles) is preferably in a range of 0.05 to 1 µm (50 to 1,000 nm), and more preferably in a range of 0.1 to 0.5 µm (100 to 500 nm). The content of the first additive fine particles (for example, PTFE fine particles) is preferably in a range of 0.1 to 15 mass%, and more preferably in a range of 5 to 10 mass% with respect to the total mass of the lubricant. In a case where the content of the first additive fine particles (for example, PTFE fine particles) is less than the lower limit, the positive charging potential of the surface and/or the tire of vehicle of this aspect to which the lubricant is applied may not be sufficiently removed. In a case where the content of the first additive fine particles (for example, PTFE fine particles) is greater than the upper limit, the lubricant has reduced fluidity, and the lubricant may not be sufficiently distributed in the microscopic dynamics friction mechanism (for example, axle rolling bearing) of the vehicle of this aspect to which the lubricant is applied.

In the lubricant, it is preferable that second additive fine particles (for example, carbon black fine particles) having a conductive property and carrying a negative potential charged on the first additive fine particles are uniformly mixed with the electrically insulating base oil so as to further significantly reduce the positive potential of the member of the friction mechanism. The second additive fine particles can be appropriately selected from those having various forms that are usually used as a conductive material, such as carbon black, carbon nanotube, carbon nanohorn, carbon nanofiber, graphene, and graphite. The second additive fine particles are preferably carbon black. The primary particle diameter of the second additive fine particles (for example, carbon black fine particles) is preferably in a range of 1 to 100 nm, and more preferably in a range of 5 to 50 nm. The content of the second additive fine particles (for example, carbon black fine particles) is preferably in a range of 0.1 to 15 mass%, and more preferably in a range of 5 to 10 mass% with respect to the total mass of the lubricant. In a case where the content of the second additive fine particles (for example, carbon black fine particles) is less than the lower limit, the neutralization and static elimination of the lubricant may not be sufficiently performed, and the positive electric charge charged on the vehicle body surface and/or the tire of the vehicle to which the lubricant is applied may not be sufficiently removed. In a case where the content of the second additive fine particles (for example, carbon black fine particles) is greater than the upper limit, the lubricant has reduced fluidity, and the lubricant may not be sufficiently distributed in the microscopic dynamics friction mechanism (for example, axle rolling bearing) of the vehicle of this aspect to which the lubricant is applied. Accordingly, since the second additive fine particles (for example, carbon black fine particles) having the characteristics are contained, the lubricant can improve steering stability and the like of the vehicle when being applied to the microscopic dynamics friction mechanism (for example, axle rolling bearing) of the vehicle of this aspect (FIGS. 19 and 20).

The first additive fine particles and the second additive fine particles are preferably uniformly mixed with the electrically insulating base oil so as to have the same mass ratio of about 5 to 10 mass% with respect to the total mass of the lubricant, respectively.

The lubricant may optionally contain one or more additional additives usually used in the art. The additional additive is not limited, and examples of the additional additive include solid additives (for example, molybdenum disulfide, graphite, and melamine cyanurate (MCA)) other than the first additive fine particles (for example, PTFE fine particles) and the second additive fine particles (for example, carbon black fine particles), extreme pressure agents (for example, olefin sulfide, sulfide ester, and sulfide fat and oil), abrasion resistant agents (for example, phosphate ester, acidic phosphoric ester, acidic phosphoric ester amine salt, zinc dithiophosphate, and zinc dithiocarbamate), oily agents (for example, alcohols, amines, esters, and animal and plant fats and oils), antioxidants (for example, phenolic antioxidants and amine-based antioxidants), rust inhibitors (for example, fatty acid amine salts, zinc naphthenates, and metal sulfonates), and metal deactivators (for example, benzotriazoles and thiadiazoles). In a case where the lubricant contains an additional additive, the additional additive may be formed of any one of the additives exemplified above, or may be formed as a mixture of a plurality of additives.

### Method of Manufacturing Lubricant

Another aspect of the present invention relates to a method of manufacturing a lubricant applied to a vehicle of one aspect of the present invention. The method of this aspect is not particularly limited, and various methods can be applied. For example, the method of this aspect includes a step of mixing an electrically insulating base oil with an additive containing first additive fine particles (for example, PTFE fine particles) and second additive fine particles (for example, carbon black fine particles) (hereinafter, also referred to as “mixing step”).

In the method of this aspect, in the manufacturing of a lubricant of an embodiment of a grease composition, the mixing step is preferably performed by mixing an electrically insulating base oil, an additive containing first additive fine particles (for example, PTFE fine particles) and second additive fine particles (for example, carbon black fine particles), and a thickener.

In the method of this aspect, the mixing step can be performed using kneading means that is usually used in the art, such as a roll mill, a Fryma mill, a Charlotte mill, or a homogenizer. In the mixing step, the order for mixing the various components is not particularly limited. For example, an additive containing first additive fine particles (for example, PTFE fine particles) and second additive fine particles (for example, carbon black fine particles) and an optional thickener may be simultaneously added to and mixed with, or separately added (for example, continuously or at predetermined intervals) to and mixed with an electrically insulating base oil.

Hereinafter, the present invention will be described in greater detail with reference to examples. However, the technical scope of the present invention is not limited to these examples.

### Preparation of Lubricant

To an electrically insulating base oil (paraffinic mineral oil, kinematic viscosity: 75 mm²/s (40° C.)), a thickener (reaction product of aromatic diurea compound, 4,4′-diphenylmethane diisocyanate, and p-toluidine), first additive fine particles (PTFE fine particles, primary particle diameter: 0.18 to 0.20 µm (180 to 200 nm)), second additive fine particles (carbon black, primary particle diameter: 10 to 20 nm), and other additives (antioxidant, rust inhibitor, and abrasion resistant agent) were added and kneaded by three roll mills to prepare lubricants having a form of a grease composition of Example 1 and Comparative Example 1. The structure of the aromatic diurea compound is shown below. Table 1 shows the contents of the components in the lubricants of Example 1 and Comparative Example 1. In the table, the content of each component is indicated by mass% based on the total mass of the lubricant.

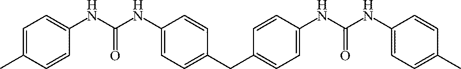

TABLE 1

| | | Example 1 | Comparative Example 1 |
|---|---|---|---|
| Electrically Insulating Base Oil | | Remainder | Remainder |
| Thickener | | 4 | 20 |
| Additive | First Additive Fine Particles (PTFE fine particles) | 5.0 | 0 |
| | Second Additive Fine Particles (carbon black fine particles) | 5.0 | 0 |
| | Other | 1.8 | 1.8 |

### Lubricant Performance Evaluation

### Measurement Test of Mixing Consistency

The mixing consistency of the lubricants of Example 1 and Comparative Example 1 was measured based on JISK22207. As a result, the mixing consistency of the lubricants of Example 1 and Comparative Example 1 was 300.

### Steering Stability Measurement Test

The lubricants of Example 1 and Comparative Example 1 were sealed in an axle rolling bearing (manufactured by JTEKT Corporation, hub unit having double-row angular ball bearing). The axle rolling bearing was assembled on four right front, right rear, left front, and left rear wheels of a test vehicle. Table 2 shows the specifications of the test vehicles.

TABLE 2

| | | | | | | |
|---|---|---|---|---|---|---|
| Example/ Comparative Example | Vehicle | Vehicle Type | L/O | Outline of Specification | Hub Unit Bearing | Tire |
| Example 1 | RX450h | GYL25W -AWXGB(L) | ‘16/8 | 3.5L-HV Xe-4WD | Lubricant of Example 1 | Standard Product 235/55/R20 |
| Comparative Example 1 | | | | | Lubricant of Comparative Example 1 | |

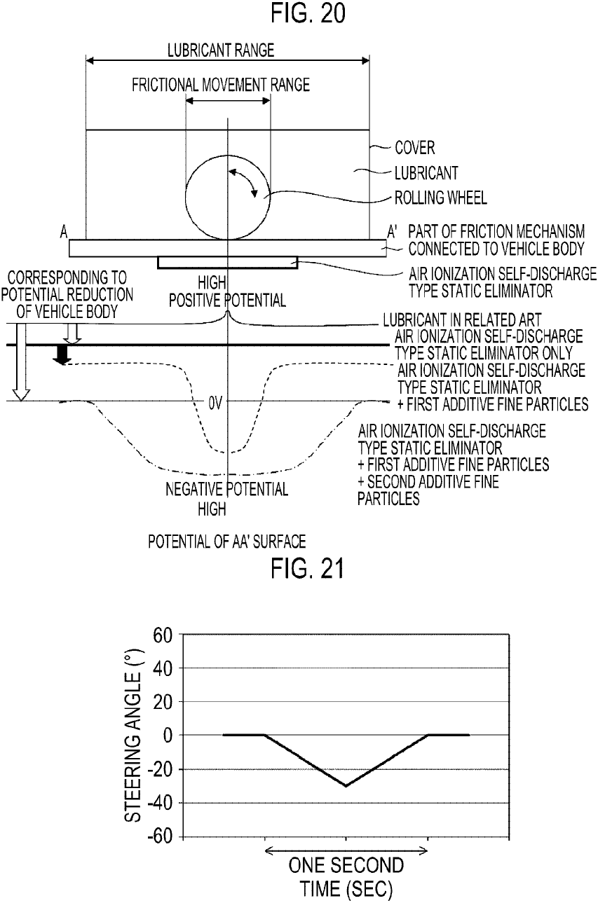

The test vehicles of Example 1 and Comparative Example 1 were allowed to travel at a speed of 70 km/h. During traveling, lane change was repeated based on the steering method during lane change shown in FIG. 21. In the steering method shown in FIG. 21, a steering angle was changed in order of 0° → -30° → 0° in 1 second (hereinafter, the change in steering angle will also be referred to as “steering angle of 60°/sec”). In the traveling test, the steering angle and the vehicle yaw angular acceleration of the test vehicles of Example 1 and Comparative Example 1 were measured. The steering angle was measured by a vehicle-mounted steering angle sensor and a CAN data logger. The vehicle yaw angular acceleration was measured by a gyro sensor (NAV440CA-200 manufactured by CROSSBOW).

In order to quantitatively measure the steering stability of the test vehicle, the responsiveness of the test vehicle to the steering of the test vehicle was evaluated. In this test, the steering of the test vehicle was measured by the steering angle, and the responsiveness of the behavior of the test vehicle was measured by the vehicle yaw angular acceleration. FIG. 22 shows values of the vehicle yaw angular accelerations at a steering angle of 60°/sec in the test vehicles of Example 1 and Comparative Example 1.

As shown in FIG. 22, the value of the vehicle yaw angular acceleration of the test vehicle of Example 1 was significantly higher than the value of the test vehicle of Comparative Example 1. From this result, it has been found that, using the lubricant of Example 1, the original vehicle performance is exhibited, the responsiveness of the test vehicle to the steering operation of the test vehicle is improved, and as a result, the steering stability of the test vehicle is improved.

### Measurement Test of Charge Removing Effect of Vehicle Body

A lubricant of Example 2 was prepared under the same conditions as described above, except that in the lubricant of Example 1, the content of the thickener was changed to 3 mass%, the content of the carbon black was changed to 5 mass%, the content of PTFE was changed to 10 mass%, the content of other additives was changed to 1.8 mass%, and the content of the base oil was changed to the remainder. A test vehicle was prepared under the same conditions as described above using the lubricant of Example 2.

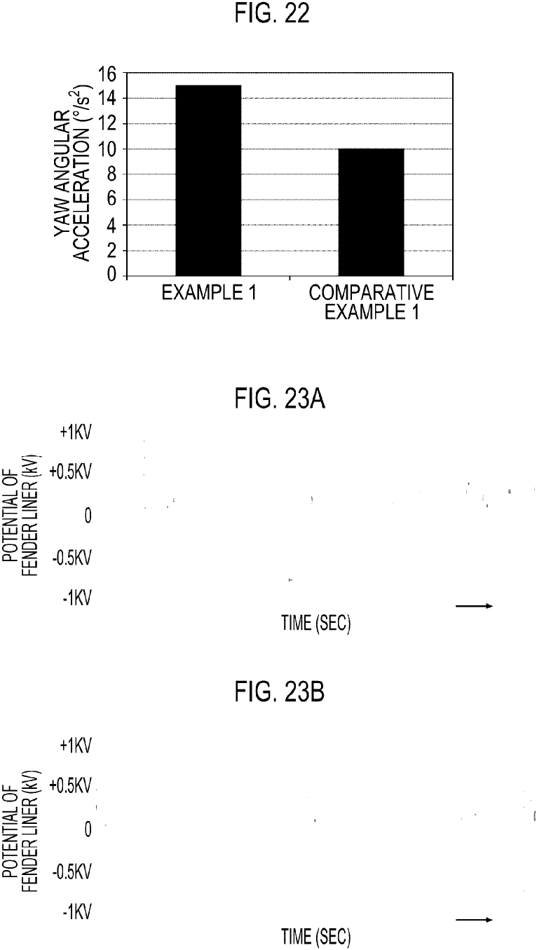

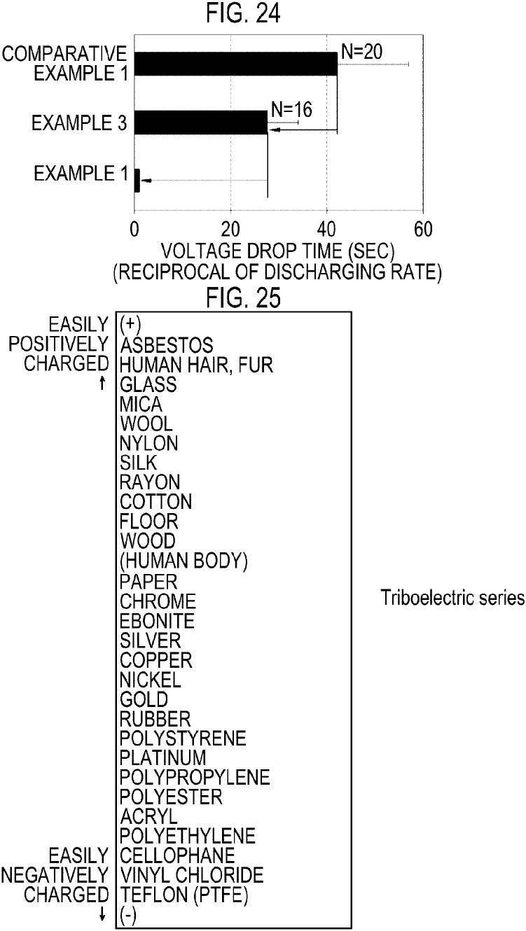

The test vehicles of Example 2 and Comparative Example 1 were allowed to travel at a speed of about 100 km/h from the start. During traveling, the potential of a tire tread surface in a rear part of the left rear wheel and the potential of a fender liner (a component facing the tire tread surface) were measured using a non-contact surface potential measuring device (capable of measuring surface potentials of the positive and negative electrodes in a range of 0.1 to 5 kV). FIGS. 23A and 23B show changes in potential of the fender liner with the passage of time. FIG. 23A shows measurement results of the test vehicle of Comparative Example 1. FIG. 23B shows measurement results of the test vehicle of Example 2. In FIGS. 23A and 23B, the horizontal axis represents the elapsed time (seconds), and the vertical axis represents the potential (kV).

As shown in FIGS. 23A and 23B, in the test vehicle of Comparative Example 1, the potential fluctuated in a range of +0.34 to -0.24 kV. In the test vehicle of Example 2, the potential fluctuated in a range of +0.09 to -0.12 kV. From the results, it has been found that, using the lubricant of Example 2, the positive potential of the vehicle body and/or the charge of the tire are removed, and thus the fluctuation of the charging potential of the vehicle body during the traveling of the vehicle is reduced to about ⅓.

### Measurement Test of Voltage Drop Time of Lubricant

A lubricant of Example 3 was prepared under the same conditions as described above, except that in the lubricant of Example 1, the content of the thickener was changed to 19 mass%, the content of PTFE was changed to 5 mass%, the content of other additives was changed to 1.8 mass%, and the content of the base oil was changed to the remainder. A measurement test of a voltage drop time was performed using the lubricants of Example 1, Example 3, and Comparative Example 1. Each lubricant was sandwiched between a pair of electrodes, and forcible charging (positive) was performed from a surface of one of the electrodes in a non-contact manner to measure the charging amount in a non-contact manner (static voltage). The time when the static voltage dropped to 0.2 kV or less was measured, and the value thereof was defined as the voltage drop time.

As shown in FIG. 24, in a case of the lubricant of Comparative Example 1 (without addition of PTFE and carbon black), the average voltage drop time was 42.2 seconds. In a case of the lubricant of Example 3 (with PTFE added), the average voltage drop time was 27.6 seconds. From the results, it has been found that using the lubricant of Example 3, the charge is neutralized. Furthermore, in a case of the lubricant of Example 1 (with PTFE and carbon black added), the average voltage drop time was within 1.0 second. From the results, it has been found that, using the lubricant of Example 1, the charge is further neutralized.

1. A vehicle having a microscopic dynamics friction mechanism formed of at least two parts and charged to a positive potential due to traveling, wherein:
at least one of members of the friction mechanism is made of a metal material,
by a microscopic dynamics frictional force with the member of the friction mechanism, a lubricant is disposed in a clearance between the members of the friction mechanism, the lubricant having therein first additive fine particles made of a resin that generates a negative potential compared to the metal material of at least one of the members of the friction mechanism in a triboelectric series table according to the frictional force uniformly mixed with an electrically insulating base oil the first additive fine particles being selected from the group consisting of polytetrafluoroethylene, vinyl chloride, acryl, polyester, polyphthalamide, polyacetal, polybutylene terephthalate, polyphenylene sulfite, polyetheretherketone, polyimide, polyamidoimide, and rubber, and the electrically insulating base oil being selected from the group consisting of hydrocarbon-based synthetic oils such as a poly-α-olefin oil containing 1-decene as a starting material and a co-oligomer oil of α-olefin and ethylene, phenyl ether-based synthetic oils, ester-based synthetic oils, polyglycol-based synthetic oils, silicone oils, hydrocarbon-based synthetic oils consisting only of carbon and hydrogen atoms, paraffinic mineral oils and naphthenic mineral oils,
while the first additive fine particles are in frictional contact with the member of the friction mechanism, neutralization and elimination of the positive potential of the member of the friction mechanism are started, and
the first additive fine particles charged to the negative potential after the frictional contact are attracted by a Coulomb force to the positive potential of a surface of the member of the friction mechanism other than a frictional contact part of the member of the friction mechanism when floating in the electrically insulating base oil and moving and circulating, and thus the neutralization and elimination of the positive potential of the member of the friction mechanism are continued.

2. The vehicle according to claim 1, wherein the first additive fine particles have a primary particle diameter in a range of 0.05 to 1 µm.

3. The vehicle according to claim 2, wherein the first additive fine particles have a primary particle diameter in a range of 0.1 to 0.5 µm.

4. The vehicle according to claim 1, wherein the first additive fine particles are uniformly mixed in a range of 0.1 to 15 mass% with respect to a total mass of the lubricant.

5. The vehicle according to claim 4, wherein the first additive fine particles are uniformly mixed in a range of 5 to 10 mass% with respect to the total mass of the lubricant.

6. The vehicle according to claim 1, wherein the first additive fine particles are polytetrafluoroethylene particles.

7. (canceled)

8. The vehicle according to claim 1, wherein:
second additive fine particles having a conductive property are uniformly mixed with the electrically insulating base oil,
when the first additive fine particles charged to the negative potential and the second additive fine particles float in the electrically insulating base oil and move and circulate, the charged negative potential is carried from the first additive fine particles to the second additive fine particles, and
the second additive fine particles charged to the negative potential are attracted by the Coulomb force to the positive potential of the surface of the member of the friction mechanism, and the positive potential of the member of the friction mechanism is neutralized, eliminated, and reduced.

9. The vehicle according to claim 8, wherein the second additive fine particles have a primary particle diameter in a range of 1 to 100 nm.

10. The vehicle according to claim 8, wherein the second additive fine particles have a primary particle diameter in a range of 5 to 50 nm.

11. The vehicle according to claim 8, wherein the second additive fine particles are uniformly mixed in a range of 0.1 to 15 mass% with respect to a total mass of the lubricant.

12. The vehicle according to claim 8, wherein the second additive fine particles are uniformly mixed in a range of 5 to 10 mass% with respect to a total mass of the lubricant.

13. The vehicle according to claim 8, wherein the second additive fine particles are selected from the group consisting of carbon black, carbon nanotube, carbon nanohorn, carbon nanofiber, graphene, and graphite.

14. The vehicle according to claim 13, wherein the second additive fine particles are carbon black particles.

15. The vehicle according to claim 8, wherein the first additive fine particles and the second additive fine particles are uniformly mixed so as to have the same mass ratio of 5 to 10 mass% with respect to a total mass of the lubricant, respectively.

16. The vehicle according to claim 1, wherein:
a thickener is mixed with the electrically insulating base oil and a solid content of the thickener is adjusted such that a total solid content is 15 to 20 mass% to prepare a grease lubricant with an adjusted viscosity index, and
the thickener is selected from the group consisting of soap-based materials and non-soap-based materials.

17. The vehicle according to claim 1, wherein the electrically insulating base oil is a paraffinic mineral oil.

18. (canceled)

19. (canceled)

20. The vehicle according to claim 1, wherein the other of the members of the friction mechanism is made of a material that generates a positive potential in the triboelectric series table, and the negative potential generated on the first additive fine particles is increased to increase an effect of neutralizing, eliminating, and reducing the positive potential of the member of the friction mechanism.

21. The vehicle according to claim 20, wherein the other of the members of the friction mechanism is made of a material selected from the group consisting of rayon, nylon, polyphthalamide, polyacetal, polybutylene terephthalate, polyphenylene sulfite, polyetheretherketone, polyimide, and polyamidoimide.

22. The vehicle according to claim 1, wherein the microscopic dynamics friction mechanism is a bearing that rolls and rubs against a rolling wheel.

23. The vehicle according to claim 1, wherein the microscopic dynamics friction mechanism is a bearing of which parts slide and rub against each other.

24. The vehicle according to claim 1, wherein the microscopic dynamics friction mechanism is a gear of which parts rotationally rub against each other.

25. The vehicle according to claim 1, wherein the microscopic dynamics friction mechanism is a worm gear of which parts rotationally rub against each other.

26. The vehicle according to claim 1, wherein the microscopic dynamics friction mechanism is a belt of which parts rotationally rub against each other.

27. The vehicle according to claim 1, wherein the microscopic dynamics friction mechanism includes a piston and a cylinder that slide and rub against each other.

28. The vehicle according to claim 1, wherein the microscopic dynamics friction mechanism is a slide rail of which parts slide and rub against each other.

29. The vehicle according to claim 1, wherein the microscopic dynamics friction mechanism includes a sleeve and a spline that slide and rub against each other.

30. The vehicle according to claim 1, wherein an air ionization self-discharge type-static eliminator that ionizes surrounding air with the positive potential of the friction mechanism and neutralizes and eliminates the positive potential of the friction mechanism is disposed on an outer surface of the friction mechanism near the member where the lubricant is disposed, and a potential of the member where the lubricant is disposed in the friction mechanism is reduced such that static elimination up to the negative potential is possible by a synergistic effect with the neutralization and static elimination of the lubricant.
